(19) United States
(12) Patent Application Publication
(10) Pub. No.: US 2025/0031242 A1
(43) Pub. Date: Jan. 23, 2025

(54) Rescheduling of Restricted Target Wake Time Service Period

(71) Applicant: Ofinno, LLC, Reston, VA (US)

(72) Inventors: Kiseon Ryu, McLean, VA (US); Jeongki Kim, Fairfax, VA (US); Esmael Hejazi Dinan, McLean, VA (US)

(73) Assignee: Ofinno, LLC, Reston, VA (US)

(21) Appl. No.: 18/909,015

(22) Filed: Oct. 8, 2024

Related U.S. Application Data
(63) Continuation of application No. PCT/US2023/017668, filed on Apr. 6, 2023.
(60) Provisional application No. 63/329,926, filed on Apr. 12, 2022.

(51) Int. Cl. H04W 74/04

(52) U.S. Cl. CPC H04W 74/04

(57) ABSTRACT

An access point (AP) multi-link device (MLD) transmits to a non-access point (non-AP) MLD, on a first link, a first frame scheduling a restricted target wake time (r-TWT) service period (SP) of a r-TWT setup for the non-AP MLD on the first link. The AP MLD transmits to the non-AP MLD, on a second link, a second frame for scheduling traffic associated with the r-TWT on the second link. The transmitting of the second frame may be responsive to a failure by the AP MLD to schedule the traffic associated with the r-TWT during the r-TWT SP on the first link.

### CROSS-REFERENCE TO RELATED APPLICATIONS

This application is a continuation of International Application No. PCT/US2023/017668, filed Apr. 6, 2023, which claims the benefit of U.S. Provisional Application No. 63/329,926, filed Apr. 12, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of target wake time (TWT) operation.

FIG. 4 illustrates an example of TWT operation in an environment including an AP multi-link device (AP MLD) and a station multi-link device (STA MLD).

FIG. 5 illustrates an example TWT element which may be used to support individual TWT operation.

FIG. 6 illustrates an example TWT element which may be used to support restricted TWT (r-TWT) operation.

FIG. 7 illustrates an example of individual TWT operation.

FIG. 8 illustrates an example of broadcast TWT operation.

FIG. 9 illustrates an example of TWT protection in individual TWT operation.

FIG. 10 illustrates an example of r-TWT operation.

FIG. 11 illustrates an example of trigger enabled r-TWT operation.

FIG. 12 illustrates an example of r-TWT operation in a multi-link environment.

FIG. 13 illustrates an example r-TWT operation according to an embodiment.

FIG. 14 illustrates an example r-TWT operation according to an embodiment.

FIG. 15 illustrates an example r-TWT operation according to an embodiment.

FIG. 16 illustrates an example process according to an embodiment.

FIG. 17 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAS, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

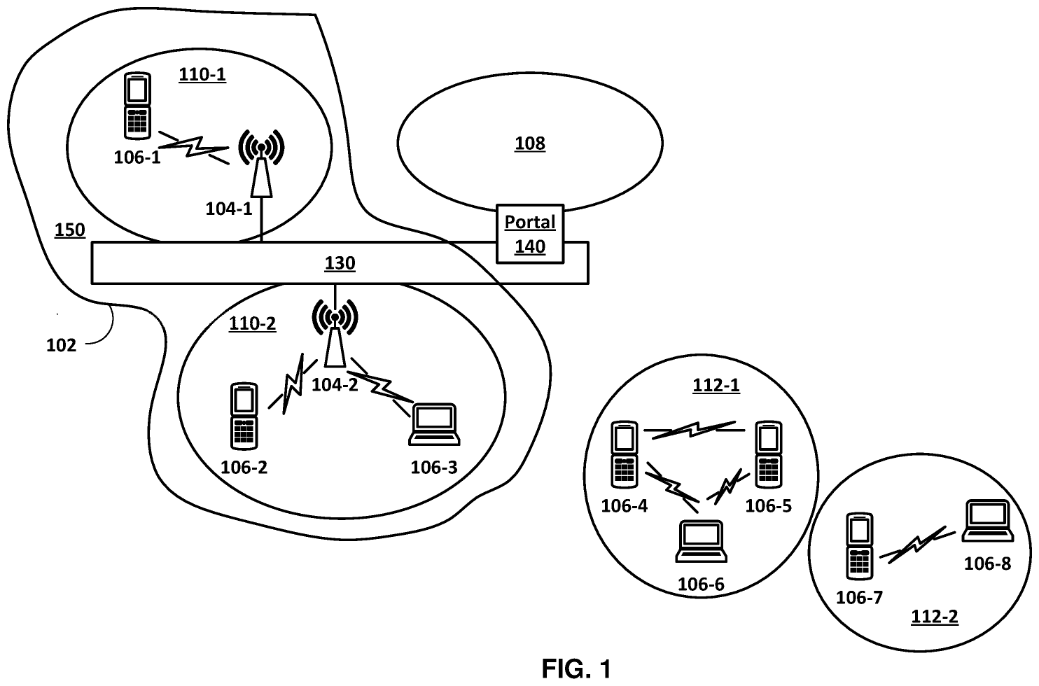

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHZ. Larger channels may be formed through channel bonding. For example, PPDUs may be transmitted over physical channels having bandwidths of 40 MHz, 80 MHz, 160 MHz, or 320 MHz by bonding together multiple 20 MHz channels.

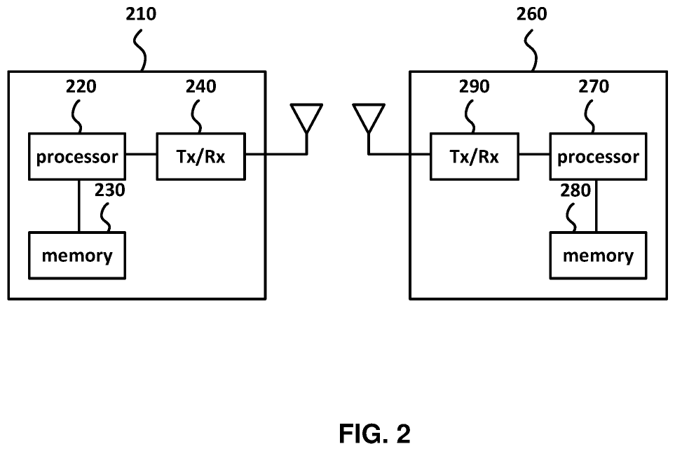

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

Target wake time (TWT), a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

In an individual TWT, a STA that requests a TWT agreement is called a TWT requesting STA. The TWT requesting STA may be a non-AP STA for example. The STA that responds to the request is called a TWT responding STA. The TWT responding STA may be an AP for example. The TWT requesting STA is assigned specific times to wake up and exchange frames with the TWT responding STA. The TWT requesting STA may communicate wake scheduling information to the TWT responding STA. The TWT responding STA may transmit TWT values to the TWT requesting STA when a TWT agreement is established between them.

When explicit TWT is employed, the TWT requesting STA may wake up and perform a frame exchange. The TWT requesting STA may receive a next TWT information in a response from the TWT responding STA. When implicit TWT is used, the TWT requesting STA may calculate a next TWT by adding a fixed value to the current TWT value.

The TWT values for implicit TWT may be periodic. The TWT requesting STA operating with an implicit TWT agreement may determine a next TWT service period (TWT SP) start time by adding a value of a TWT wake interval associated with the TWT agreement to the value of the start time of the current TWT SP. The TWT responding STA may include the start time for a series of TWT SPs corresponding to a single TWT flow identifier of an implicit TWT agreement in a target wake time field of a TWT element. The TWT element may contain a value of ‘accept TWT’ in a TWT setup command field. The start time of the TWT SP series may indicate the start time of a first TWT SP in the series. Start times of subsequent TWT SPs may be determined by adding the value of the TWT wake interval to the start time of the current TWT SP. In an example, the TWT requesting STA, awake for an implicit TWT SP, may enter a doze state after the TWT SP has elapsed or after receiving an end of service period (EOSP) field equal to 1 from the TWT responding STA, whichever occurs first.

A TWT session may be negotiated between an AP and a STA. The TWT session may configure a TWT SP of DL and UL traffic between the AP and the STA. Expected traffic may be limited within the negotiated SP. The TWT SP may start at a specific time. The TWT SP may run for a SP duration. The TWT SP may repeat every SP interval.

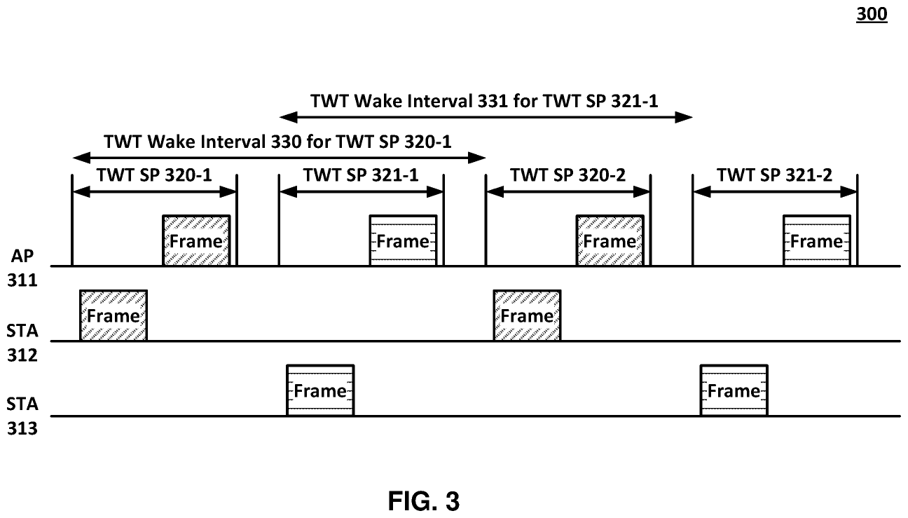

FIG. 3 illustrates an example 300 of TWT operation. As shown in FIG. 3, example 300 includes an AP 311, a STA 312, and a STA 313. AP 311 and STA 312 may establish a TWT SP 320. AP 311 and STA 313 may establish a TWT SP 321. TWT SP 320 and TWT SP 321 may repeat as shown in FIG. 3, such that TWT SP 320 may include a first TWT SP 320-1 and a second TWT SP 320-2, and such that TWT SP 321 may include a first TWT SP 321-1 and a second TWT SP 321-2.

AP 311 and STA 312 may exchange frames during first TWT SP 320-1. STA 312 may enter a doze state at the end of TWT SP 320-1 and may remain in the doze state until the start of second TWT SP 320-2. The start of second TWT SP 320-2 may be indicated by a TWT wake interval 330 associated with TWT SP 320. AP 311 and STA 312 may again exchange frames during second TWT SP 320-2.

Similarly, AP 311 and STA 313 may exchange frames during first TWT SP 321-1. STA 313 may enter a doze state at the end of first TWT SP 321-1 and may remain in the doze state until the start of second TWT SP 321-2. The start of second TWT SP 321-2 may be indicated by a TWT wake interval 331 associated with TWT SP 321. AP 311 and STA 313 may again exchange frames during second TWT SP 31-2.

In an awake state, a STA may be fully powered. The STA may transmit and/or receive a frame to/from an AP or another STA. In a doze state, a STA may not transmit and may not receive a frame to/from an AP or another STA.

An MLD is an entity capable of managing communication over multiple links. The MLD may be a logical entity and may have more than one affiliated station (STA). The MLD may have a single MAC service access point (MAC-SAP) to the LLC layer, which includes a MAC data service. An MLD may be an access point MLD (AP MLD) when a STA affiliated with the MLD is an AP STA (or an AP). An MLD may be a non-access point MLD (non-AP MLD) or STA MLD when a STA affiliated with the MLD is a non-AP STA (or a STA).

During negotiation of TWT agreements, a TWT requesting STA affiliated with a STA MLD and a TWT responding STA affiliated with an AP MLD may communicate multiple TWT elements. The TWT elements may comprise link ID bitmap subfields indicating different link(s) in a TWT setup frame. The TWT parameters provided by a TWT element may be applied to the respective link that is indicated in the TWT element.

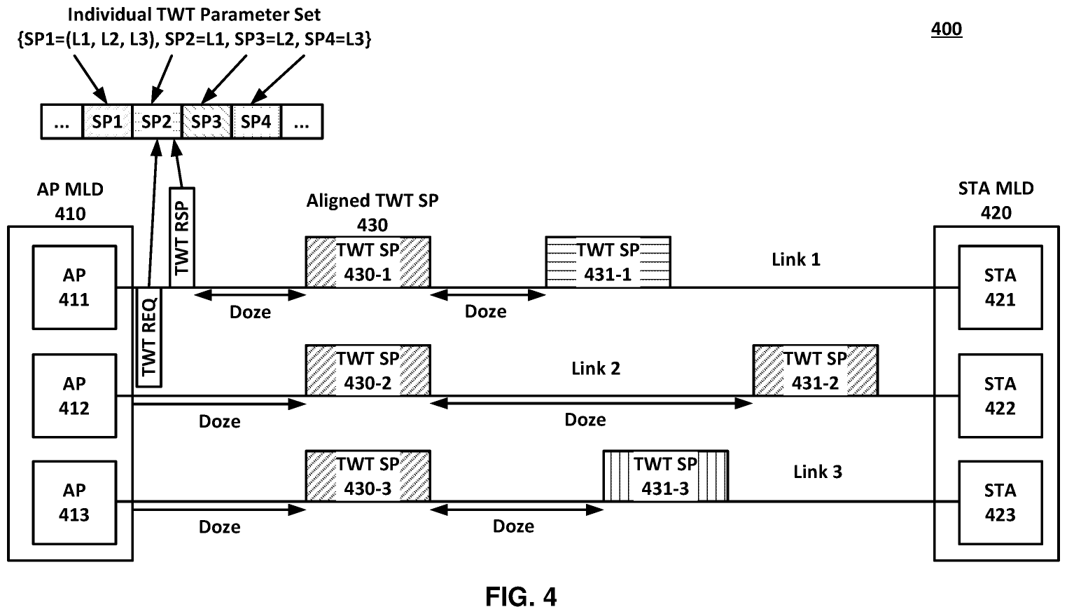

FIG. 4 illustrates an example 400 of TWT operation in a multi-link environment including an AP multi-link device (AP MLD) 410 and a STA multi-link device (STA MLD) 420. As shown in FIG. 4, AP MLD 410 may have three affiliated APs, AP 411, AP2 412, and AP3 413. In an example, AP 411, AP2 412, and AP3 413 may operate respectively on the 2.4 GHz band, the 5 GHz band, and the 6 GHz band. STA MLD 420 may have three affiliated STAs, STA 421, STA 422, and STA 423. In an example, STA 421, STA 422, and STA 423 may operate respectively on the 2.4 GHz band, the 5 GHz band, and the 6 GHz band. In an example, AP 411, AP2 412, and AP3 413 may be communicatively coupled via a first link (link 1), a second link (link 2), and a third link (link 3) respectively with STA 421, STA 422, and STA 423, respectively.

In an example, STA 421 may transmit a TWT request to AP 411. The TWT request may include three TWT elements. Each TWT element may indicate a respective link of links 1-3 and may request the setup of a TWT agreement for the indicated link. The three TWT elements may have different TWT parameters, such as target wake time (TWT). In response to the TWT request, AP 411 may transmit a TWT response to STA 421. The TWT response may include three TWT elements. Each TWT element may indicate a respective link of links 1-3 and may include a value of ‘accept TWT’ in a TWT setup command field.

Successful TWT agreement setup on links 1-3 establishes three TWT SPs with same or different TWT parameters on links 1-3 respectively. The target wake time field of the TWT element indicating a given link indicates the start time of the TWP SP for that link. The starting time may be indicated in reference to a time synchronization function (TSF) time of the link.

In example 400, initial TWT SPs 430-1, 430-2, and 430-3 of links 1-3 respectively may be aligned. TWT wake intervals associated with the TWT agreements of links 1-3 respectively may be set differently. As such, second TWT SPs 431-1, 431-2, and 431-3 of links 1-3 respectively may not be aligned. STA 421, STA 422, and STA 423 may enter a doze state between the end of initial TWT SPs 430-1, 430-2, and 430-3, respectively, and the start of second TWT SPs 431-1, 431-2, 431-3, respectively.

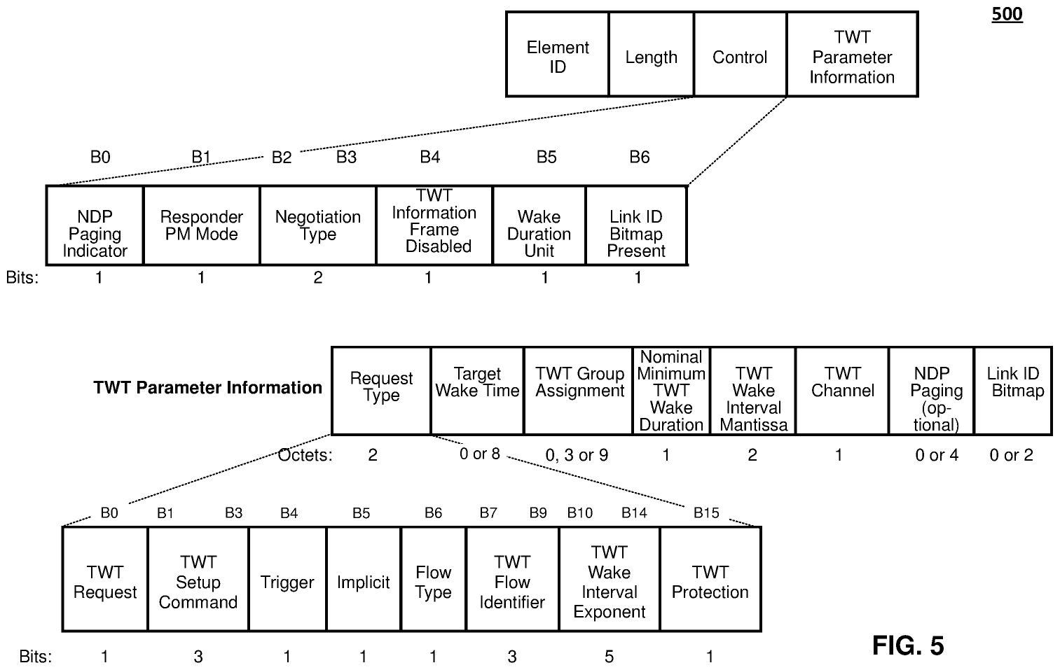

FIG. 5 illustrates an example target wake time (TWT) element 500 which may be used to support individual TWT operation.

In an example, an AP and a STA may use TWT element 500 to negotiate a TWT agreement. The AP and/or the STA may transmit TWT element 500 in an individually addressed management frame. The management frame may be of the type action, action no ack, (re) association request/response, and probe request response, for example.

The TWT schedule and parameters may be provided during a TWT setup phase. Renegotiation/changes of TWT schedules may be signaled via individually addressed frames that contain the updated TWT schedule/parameters. The frames may be management frames as described above or control or data frames that carry a field containing the updated TWT schedule/parameters.

Referring to FIG. 5, TWT element 500 includes an element ID field, a length field, a control field, and a TWT parameter information field.

The element ID field (e.g., 1 octet in length) may indicate that information element 500 is a TWT element. The length field (e.g., 1 octet) may indicate the length of TWT element 500 starting from the control field until an end of TWT element 500. The end of TWT element 500 may be the end of a TWT Channel field or the end of a Link ID bitmap field of the TWT parameter information field.

The TWT parameter information field may include a request type field (e.g., 2 octets), a target wake time field (e.g., 8 octets or less), a TWT group assignment field (e.g., 9, 3, 2, or 0 octets), a nominal minimal TWT wake duration field (e.g., 1 octet), a TWT wake interval mantissa (e.g., 2 octets), a TWT channel field (e.g., 1 octet), an optional NDP paging field (e.g., 0 or 4 octets), and/or a Link ID bitmaps field (e.g., 0 or 2 Octets).

The request type field may indicate a type of TWT request. The request type field may include a TWT request field (e.g., 1 bit), a TWT setup command field (e.g., 3 bits), a trigger field (e.g., 1 bit), an implicit field (e.g., 1 bit), a flow type (e.g., 1 bit), a TWT flow identifier (e.g., 3 bits), a TWT wake interval exponent (e.g., 5 bits), and/or a TWT protection field (e.g., 1 bit).

The TWT request field may indicate whether the TWT element 500 represents a request. If TWT request field has a value of 1, then the TWT element 500 may represent a request to initiate TWT scheduling/setup.

The TWT setup command field may indicate a type of TWT command. In a TWT request, the type of TWT command indicated may be: a request TWT (the TWT responding STA specifies the TWT value; e.g., field set to 0), a suggest TWT (the TWT requesting STA suggests a TWT value; e.g., field set to 1), and a demand TWT (the TWT requesting STA demands a TWT value; e.g., field set to 2).

In a TWT response, the type of TWT command indicated may be: TWT grouping (the TWT responding STA suggests TWT group parameters that are different than the suggested or demanded TWT parameters of the TWT requesting STA; e.g., field set to 3), accept TWT (the TWT responding STA accepts the TWT request with the TWT parameters indicated by the TWT requesting STA; e.g. field set to 4), alternate TWT (the TWT responding STA suggests TWT parameters that are different than the parameters suggested or demanded by the TWT requesting STA; e.g., field set to 5), dictate TWT (the TWT responding STA demands TWT parameters that are different than the parameters suggested or demanded by the TWT requesting STA; e.g., field set to 6), or reject TWT (the TWT responding STA rejects the TWT setup; e.g. field set to 7).

In a TWT response, the TWT command may also indicate an unsolicited response or a broadcast TWT. An unsolicited TWT response is an individually addressed frame that is intended for a specific STA. An unsolicited TWT response may be followed by an ACK frame from the STA receiving the unsolicited TWT response. A broadcast TWT may be intended for multiple STAs and may be carried in a broadcast frame such as, for example, a beacon frame. A broadcast TWT may not be acknowledged by receiving STAs.

An unsolicited TWT response may be used a TWT responding STA to demand that a recipient follow a TWT schedule contained in the TWT element. In an embodiment, an unsolicited TWT response may have the TWT request field set to 0 and a value of ‘dictate TWT’ in the TWT setup command field. A broadcast TWT response may be used by a TWT responding STA to schedule a TWT for any STA that receives and decodes the TWT element.

In certain embodiments, a TWT element, such as TWT element 500, may contain TWT parameter sets for multiple TWT negotiations or indications as described herein. As such, the TWT element may include multiple instances of the Control and the TWT parameter information fields. The TWT flow identifier of the request type field indicates the TWT negotiation which parameters are carried by the TWT parameter information field.

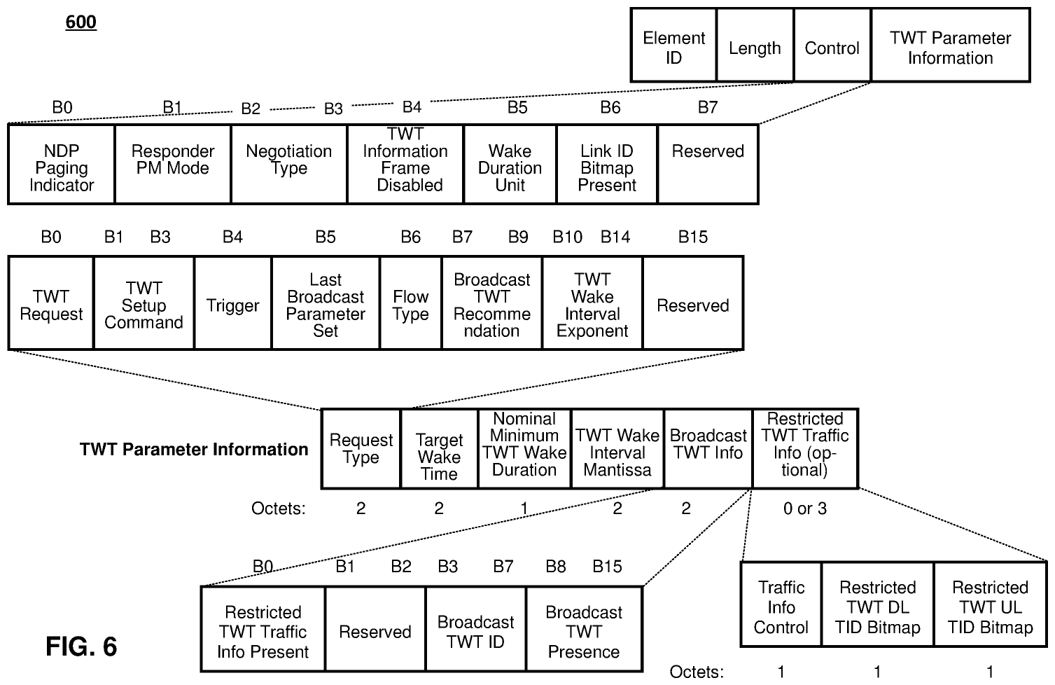

FIG. 6 illustrates an example target wake time (TWT) element 600 which may be used to support restricted TWT (r-TWT) operation. For r-TWT, TWT element 600 may be transmitted in a broadcast management frame, which can be a beacon frame, a TIM broadcast frame, a probe response frame, etc. In this embodiment, TWT element 600 provides non-negotiated TWT schedules (e.g., broadcast TWT schedules).

As shown, TWT element 600 includes an element ID field, a length field, a control field, and a TWT parameter information field.

The element ID field (e.g., 1 octet in length) may indicate that information element 600 is a TWT element. The length field (e.g., 1 octet) may indicate the length of TWT element 600 starting from the control field until an end of TWT element 600. The end of TWT element 600 may be the end of a broadcast TWT info field or the end of a r-TWT traffic info field of the TWT parameter information field.

The TWT parameter information field may include a request type field, a target wake time field (e.g., 2 octets), a nominal minimal TWT wake duration field (e.g., 1 octet), a TWT wake interval mantissa (e.g., 2 octets), a broadcast TWT info field (e.g., 2 octets), and an optional r-TWT traffic info field (e.g., 0 or 3 octets).

The request type field may include, among other fields, a TWT request field, a flow type field, and a TWT wake interval exponent field.

The TWT request field indicates whether TWT element 600 is a request. If the TWT request field has a value of 0, then TWT element 600 may represent a response to a request to initiate TWT scheduling/setup (solicit TWT), an unsolicited TWT response, and/or a broadcast TWT message.

The TWT wake interval represents the average time that a TWT requesting STA or a TWT scheduled STA expects to elapse between successive TWT SP start times of a TWT schedule. The TWT wake interval exponent field indicates a (base 2) exponent used to calculate the TWT wake interval in microseconds. In an embodiment, the TWT wake interval is equal to: (TWT wake interval mantissa)×2 (TWT Wake Interval Exponent). The TWT wake interval mantissa value is indicated in microseconds, base 2 in a TWT wake interval mantissa field of the TWT parameter information field.

The nominal minimum TWT wake duration field may indicate the minimum amount of time (in the unit indicated by a wake duration unit subfield of the control field) that a TWT requesting STA or a TWT scheduled STA is expected to be awake to complete frame exchanges for the period of the TWT wake interval.

The flow type field, in a TWT response that successfully set up a TWT agreement between a TWT requesting STA and a TWT responding STA, may indicate a type of interaction between the TWT requesting STA and the TWT responding STA within a TWT SP of the TWT agreement. A flow type field equal to 0 may indicate an announced TWT. In an announced TWT, the TWT responding STA may not transmit a frame to the TWT requesting STA within a TWT SP until the TWT responding STA receives a PS-Poll frame or a QoS Null frame from the TWT requesting STA. A flow type field equal to 1 may indicate an unannounced TWT. In an unannounced TWT, the TWT responding STA may transmit a frame to the TWT requesting STA within a TWT SP before it has received a frame from the TWT requesting STA.

Within a TWT element that includes a TWT setup command value of ‘request TWT’, ‘suggest TWT’, or ‘demand TWT’, a broadcast TWT ID may indicate a specific broadcast TWT in which the TWT requesting STA is requesting to participate. Within a TWT element that includes a TWT setup command value of ‘accept TWT’, ‘alternate TWT’, ‘dictate TWT’, or ‘reject TWT’, a broadcast TWT ID may indicate a specific broadcast TWT for which the TWT responding STA is providing TWT parameters. The value 0 in the broadcast TWT ID subfield may indicate the broadcast TWT whose membership corresponds to all STAs that are members of the BSS corresponding to the BSSID of the management frame carrying the TWT element and that is permitted to contain trigger frames with random access resource units for unassociated STAs. The Broadcast TWT ID subfield in a r-TWT Parameter set field is always set to a nonzero value.

A broadcast TWT element 600 that contains a r-TWT parameter set is also referred to as a r-TWT element. A r-TWT traffic info present subfield of the broadcast TWT info field may be set to 1 to indicate the presence of the r-TWT traffic info field in TWT element 600. The r-TWT traffic info field is present in ar-TWT parameter set field when the r-TWT traffic info present subfield is set to 1.

The r-TWT traffic info field may include a traffic info control field, a r-TWT DL TID bitmap field, and a r-TWT UL TID bitmap field.

The traffic info control field may include a DL TID bitmap valid subfield and an UL TID bitmap valid subfield. The DL TID bitmap valid subfield indicates if the r-TWT DL TID bitmap field has valid information. When the value of the DL TID bitmap valid subfield is set to 0, it may indicate that DL traffic of TIDs is identified as latency sensitive traffic, and the r-TWT DL TID bitmap field is reserved. The UL TID bitmap valid subfield may indicate if the r-TWT UL TID bitmap field has valid information. When the value of the UL TID bitmap valid subfield is set to 0, it may indicate that UL traffic of TIDs is identified as latency sensitive traffic, and the r-TWT UL TID bitmap field is reserved.

The r-TWT DL TID bitmap subfield and the r-TWT UL TID bitmap subfield may specify which TID(s) are identified by the TWT scheduling AP or the TWT scheduled STA as latency sensitive traffic streams in a downlink and a uplink direction, respectively. A value of 1 at bit position k in the bitmap indicates that TID k is classified as a latency sensitive traffic stream. A value of 0 at bit position k in the bitmap indicates that TID k is not classified as a latency sensitive traffic stream.

An individual target wake time (TWT) may be a specific time or set of times negotiated between two individual stations (e.g., a STA and another STA, or a STA and an AP, etc.) at which the stations may be awake to exchange frames during a service period (SP) of the TWT.

In trigger-enabled TWT, an AP may transmit a trigger frame for scheduling uplink multi-user transmissions from one or more STAs using uplink OFDMA (orthogonal frequency division multiple access) and/or uplink MU-MIMO (multi-user multiple input multiple output) during a trigger-enabled TWT SP. A TWT STA that receives the trigger frame from the AP may transmit a frame to the AP through a resource indicated in the trigger frame during the trigger-enabled TWT SP.

In non-trigger-enabled TWT, an AP may not be required to transmit a trigger frame to schedule uplink multi-user transmissions from one or more STAs during a non-trigger-enabled TWT SP.

In announced TWT, a STA may transmit a frame (e.g., a PS-Poll frame or a QoS null frame) to the AP to retrieve a downlink buffered data from the AP during a TWT SP. In unannounced TWT, an AP may transmit downlink data to a TWT STA without receiving a frame (e.g., a PS-Poll frame, or a QoS null frame) from the TWT STA during a TWT SP.

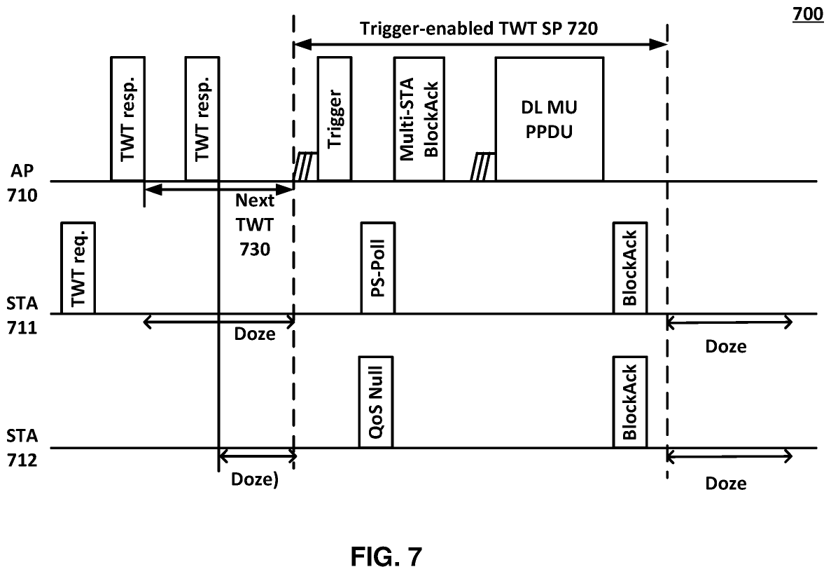

FIG. 7 illustrates an example 700 of individual TWT operation. As shown in FIG. 7, example 700 includes an AP 710, a STA 711, and a STA 712. In an example, AP 710 may be a TWT responding STA and STA 711 and STA 712 may be TWT requesting STAs.

In an example, STA 711 may transmit a TWT request to AP 710 to setup a first trigger-enabled TWT agreement. STA 711 may set a trigger field of the TWT request to 1 to indicate that it is requesting a trigger-enabled TWT. AP 710 may accept the first TWT agreement with STA 711. AP 710 may confirm the acceptance in a TWT response sent to STA 711. The TWT response may indicate a next TWT 730, which indicates the time until a next TWT SP 720 according to the first TWT agreement.

In an example, AP 710 may transmit an unsolicited TWT response to STA 712 to set up a second trigger-enabled TWT agreement with STA 712 without receiving a TWT request from STA 712. The first and second TWT agreements may be set up as announced TWTs.

After the setup of the TWT agreements, STA 711 and STA 712 may enter a doze state until the start of TWT SP 720. During trigger-enabled TWT SP 720, AP 710 may transmit a trigger frame. STA 711 and STA 12 may respond to the trigger frame by indicating that they are in awake state. In an example, STA 711 may transmit a power save poll (PS-Poll) frame. The PS-Poll frame may comprise a BSSID (receiver address: RA) field set to an address of AP 710 and a transmitter address (TA) field set to an address of STA 711. In an example, STA 712 may transmit a QoS null frame in response to the trigger frame. The QoS null frame may comprise a MAC header (e.g., a frame control field, a duration field, address fields, a sequence control field, QoS control field) without a frame body.

In response to the PS-Poll frame and the QoS null frame, AP 710 may transmit a multi-STA Block Ack (M-BA) frame. The M-BA frame may include acknowledgement information associated with the PS-Poll frame and the QoS null frame received from STAs 711 and 712 respectively. Subsequently, STA 711 and STA 712 may receive downlink bufferable units (DL BUs) from AP 710. The DL BUs may include a medium access control (MAC) service data unit (MSDU), an aggregate MAC service data unit (A-MSDU), and/or a bufferable MAC management protocol data unit (MMPDU). STA 711 and STA 712 may transmit Block Ack (BA) frames in response to the DL BUs. At the end of the TWT SP 720, STA 711 and STA 712 may return to a doze state.

A STA may execute individual TWT setup exchanges. The STA may not transmit frames to an AP outside of negotiated TWT SPs. The STA may not transmit frames that are not contained within high efficiency trigger-based physical protocol data units (HE TB PPDUs) to the AP within trigger-enabled TWT SPs. A HE TB PPDU may be transmitted by a STA based on receiving a trigger frame triggering uplink multi-user transmissions.

The AP of a trigger-enabled TWT agreement may schedule for transmission a trigger frame for a STA within the trigger-enabled TWT SP. The STA may transmit an HE TB PPDU as a response to the trigger frame sent during the trigger-enabled TWT SP. A STA that is in power save (PS) mode may include a PS-Poll frame or a QoS null frame in the HE TB PPDU if the TWT is an announced TWT, to indicate to the AP that the STA is currently in the awake state. The AP that receives the PS-Poll frame or the QoS Null frame or any other indication from an STA in PS mode, may deliver to the STA as many buffered BUs as are available at the AP during the TWT SP.

A broadcast target wake time (TWT) may be a specific time or set of times broadcast by an AP to one or more STAs at which the STAs may be awake to exchange frames with the AP during a SP of the TWT.

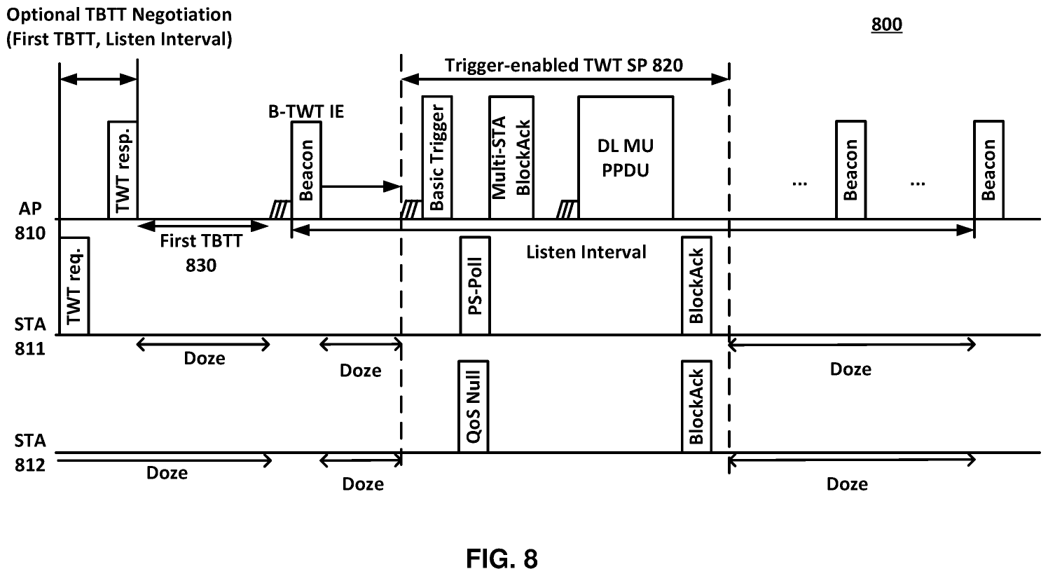

FIG. 8 illustrates an example 800 of broadcast TWT operation. As shown in FIG. 8, example 800 includes an AP 810, a STA 811, and a STA 812. In an example 800, AP 810 may be a TWT scheduling AP and STA 811 and STA 812 may be TWT scheduled STAs.

In an example, AP 810 may include a broadcast TWT element in a beacon frame that indicates a broadcast TWT SP 820. During the broadcast TWT SP 820, AP 810 may transmit trigger frames or DL BUs to STA 811 and STA 812. Beacon frames may be sent by AP 810 at a regular interval defined as the target beacon transmission time (TBTT). The TBTT is a time interval measured in time units (TUs). A TU is equal to 1024 microseconds.

In an example, STA 811 and STA 812 may enter a doze state until the first target beacon transmission time (TBTT). STA 811 and STA 812 may wake up to receive the beacon frame at the first TBTT to determine the broadcast TWT. Upon reception of a broadcast TWT element in a beacon frame, STA 811 and STA 812 may re-enter the doze state until the start of trigger-enabled TWT SP 820.

During trigger-enabled TWT SP 820, AP 810 may transmit a basic trigger frame to STA 811 and STA 812. STA 811 may indicate that it is awake by transmitting a PS-Poll, and STA 812 may indicate that it is awake by transmitting a QOS null frame in response to the basic trigger frame. Subsequently, STA 811 and STA 812 may receive DL BUs from AP 810. STA 811 and STA 812 may return to the doze state outside of the TWT SP 720.

In an example, a STA that intends to operate in power save mode may negotiate a wake TBTT and a wake interval with the AP. For example, as shown in FIG. 8, STA 811 may transmit a TWT request to AP 810 that identifies a wake TBTT of the first beacon frame and a wake interval between subsequent beacon frames. AP 810 may respond with a TWT response to the TWT request confirming the wake TBTT and wake interval. After successfully completing the negotiation, STA 811 may enter a doze state until a first negotiated wake TBTT 830. STA 811 may be in an awake state to listen to the beacon frame transmitted at first negotiated wake TBTT 830. If STA 811 receives a beacon frame from AP 810 at or after TBTT 830, STA 811 may return to the doze state until the next wake TBTT unless a traffic indication map (TIM) element in a beacon frame includes a positive indication for STA 811. The STA 811 may return to the doze state after a nominal minimum TBTT wake duration time has elapsed from the TBTT start time.

A Network Allocation Vector (NAV) is an indicator, maintained by a station (STA), of time periods when transmission onto the wireless medium (WM) may not be initiated by the STA regardless of whether the clear channel assessment (CCA) function of the STA senses that the WM is busy. A STA that receives at least one valid frame in a PSDU may update its NAV with the information from any valid duration field in the PSDU. The STA may update the NAV when a value of the received duration field is greater than the current NAV value of the STA.

A TWT protection is a mechanism employed to protect a TWT session from external STA transmissions. During a TWT SP configured to protect the TWT session, a STA that initiates a transmission opportunity (TXOP) to transmit a frame may transmit a request to transmit (RTS) frame or a clear to transmit (CTS) frame to protect the TWT session by setting the NAV of other STAs based on receiving of the RTS frame and/or the CTS frame. The RTS frame may comprise a frame control field, a duration field, a receiver address (RA) field, a transmitter address (TA) field, and a frame check sequence (FCS) field. The CTS frame may comprise a frame control field, a duration field, a receiver address (RA) field, and a frame check sequence (FCS) field.

The TWT protection field in a TWT element may indicate whether a TWT is protected or unprotected. A TWT requesting STA may set the TWT protection field to 1 to request the TWT responding STA to provide protection for the set of TWT SPs. A TWT protection field equal to 1 may indicate to use a NAV protection mechanism to protect access to the medium during the corresponding TWT SPs.

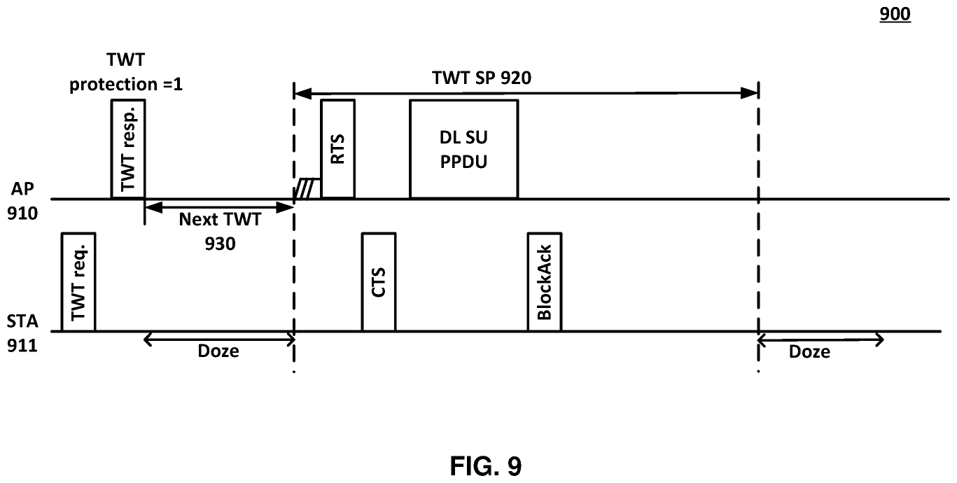

FIG. 9 illustrates an example 900 of TWT protection in individual TWT operation. As shown in FIG. 9, example 900 includes an AP 910 and a STA 911.

In an example, AP 910 may set the TWT protection field to 1 in a TWT response frame to protect the TWT SPs using a NAV protection mechanism. Upon reception of the TWT response frame, STA 911 may enter a doze state until the next TWT 930. AP 910 that has set the TWT protection field to 1 may transmit a NAV setting frame at the start of the TWT SP 920. For example, the NAV setting frame may be an RTS frame or a CTS frame.

A STA that receives the NV setting frame and that is not scheduled to access the medium during the TWT SP 920 may set their NAV according to the NAV setting frame. The STA may not access the medium for the specified amount of time in the NAV setting frame.

STA 911 may be scheduled to access the medium during the TWT SP 920. STA 911 may respond to the RTS frame with a CTS frame. Upon receiving the CTS frame, AP 910 may transmit a downlink frame to STA 911. STA 911 may respond to the downlink frame with a BA frame. When the TWT SP 920 ends, STA 911 may return to the doze state.

Traffic originating from many real time applications may have stringent latency requirements (e.g., very low average latency, worst-case latency on the order of a few to tens of milliseconds, and small jitter). Such traffic is referred to as latency sensitive traffic. R-TWT operation may allow an AP to use enhanced medium access protection and resource reservation mechanisms to provide more predictable latency, reduced worst case latency, and/or reduced jitter, with higher reliability for latency sensitive traffic.

Using TWT, a STA may negotiate awake periods with an AP to transmit and receive data packets. The STA may save power the rest of the time as the STA may remain in a doze state. TWT operation may thus lead to low power consumption for the participating STAs. TWT operation may also reduce the contention level and may support a collision-free and deterministic operation when STAs are distributed over different TWT sessions.

Using r-TWT (r-TWT) operation, an AP may allocate r-TWT SP(s) that may be used for transmission of data frames with latency sensitive traffic by the AP and one or more STAs. Traffic identifiers (TIDs) of latency sensitive traffic may be indicated in a broadcast frame (e.g., beacon frame, probe response frame, etc.) sent by the AP. The TIDs may be indicated in a r-TWT DL TID bitmap and/or a r-TWT UL TID bitmap of a r-TWT traffic info field of a TWT element. A data frame with a TID that is not identified as latency sensitive traffic may not be transmitted during an r-TWT SP.

Ar-TWT scheduling AP, referred to as an r-TWT scheduling AP, may be an extremely high throughput AP (EHT AP) that supports r-TWT operation. A r-TWT scheduled STA, referred to as an r-TWT scheduled STA, is a non-AP EHT STA that supports r-TWT operation. When a r-TWT agreement is set up, the EHT AP may announce a r-TWT SP (r-TWT SP) schedule information in a broadcast TWT element. The broadcast TWT element may be contained in a management frame such as a beacon frame or a probe response frame.

The EHT AP may schedule a quiet interval that overlaps with a r-TWT SP. The quiet interval may have a duration of 1 TU. The quiet interval may start at the same time as the corresponding r-TWT SP. A quiet interval may be scheduled by including a quiet element in a beacon frame and/or a probe response frame. Legacy STAs may not be permitted to initiate a frame transmission during the quiet interval overlapping with the r-TWT SP.

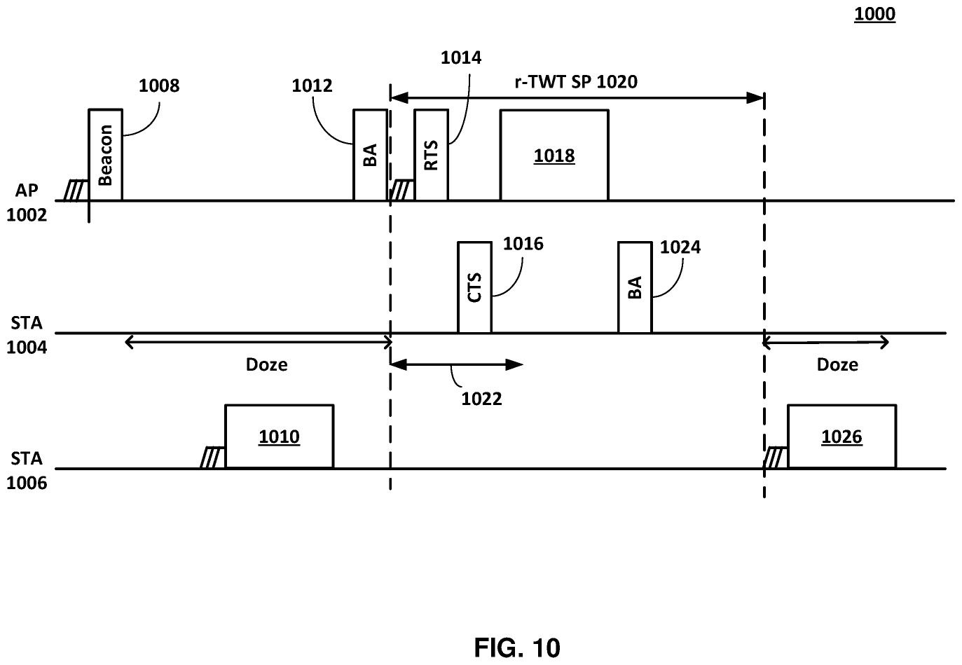

FIG. 10 illustrates an example 1000 of r-TWT operation. As shown in FIG. 10, example 1000 includes an AP 1002, a STA 1004, and a STA 1006.

In an example, an r-TWT agreement (hereinafter “r-TWT”) may be setup between AP 1002 and STA 1004. The r-TWT may not include STA 1006. For example, STA 1006 may be a legacy STA or an EHT STA not scheduled by AP 1002 as part of the r-TWT agreement.

In an example, AP 1002 may transmit a beacon frame 1008 including a TWT element that indicates an r-TWT SP 1020 of the setup r-TWT and TIDs allowed to be transmitted during the setup r-TWT. Beacon frame 1008 may also include a quiet element indicating a quiet interval 1022.

Upon receiving beacon frame 1008, STA 1004 may enter a doze state and may remain in the doze state until the start of r-TWT SP 1020. STA 1006, which is not scheduled by AP 1002 for r-TWT SP 1020, may transmit a data frame 1010 after receiving beacon frame 1008. However, STA 1006 must end its transmission before the start of r-TWT SP 1020. AP 1002 may transmit a BA frame 1012 in response to data frame 1010.

During r-TWT SP 1020, AP 1002 and STA 1004 may exchange an RTS frame 1014 and a CTS frame 1016. Subsequently, AP 1002 may send a data frame 1018 to STA 1004. Data frame 1018 includes traffic having a TID from among the TIDs indicated as permitted to transmit during r-TWT SP 1020 in beacon frame 1008. STA 1004 may respond with a BA frame 1024 to data frame 1018.

STA 1006 may not access the medium at least during quiet interval 1022 indicated in beacon frame 1008. When quiet interval 1022 or r-TWT SP 1020 ends, STA 1006 may resume transmission by transmitting a data frame 1026. STA 1004 may return to the doze state at the end of r-TWT SP 1020.

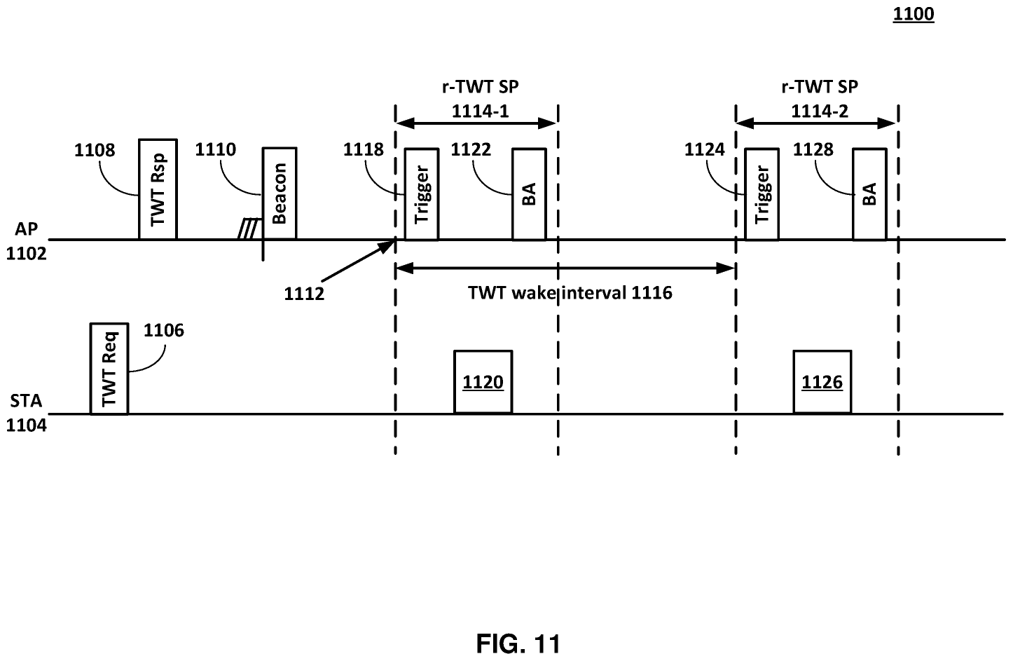

FIG. 11 illustrates an example 1100 of trigger enabled r-TWT operation. As shown in FIG. 11, example 1100 includes and AP 1102 and a STA 1104.

In an example, STA 1104 may transmit a TWT setup request frame 1106 to AP 1102. TWT setup request frame 1106 may include a first broadcast TWT element. The first broadcast TWT element may include a first r-TWT parameter set for a requested r-TWT.

In an example, the requested r-TWT may be a trigger-enabled r-TWT. In an embodiment, a trigger field of the first r-TWT parameter set may be set to 1 to indicate that the requested r-TWT is trigger-enabled.

The first r-TWT parameter set may include first DL/UL bitmaps that indicate respectively first DL/UL TIDs. The first DL/UL TIDs may correspond to DL/UL traffic that may be transmitted during SPs of the requested r-TWT. The DL/UL traffic identified by the first DL/UL TIDs may represent latency sensitive traffic.

The first r-TWT parameter set may include a broadcast TWT (b-TWT) identifier identifying a b-TWT membership group associated with the requested r-TWT. The b-TWT identifier may have a value greater than 0.

In response to TWT setup request frame 1106, AP 1102 may respond with a TWT setup response frame 1108. TWT setup response frame 1108 may include a second broadcast TWT element. The second broadcast TWT element may include a second r-TWT parameter set for the requested r-TWT.

The second r-TWT parameter set may include similar parameters as contained in the first r-TWT parameter set. The values of the parameters of the second r-TWT parameter set may be the same or different than the values of the parameters of the first r-TWT SP. In other words, AP 1102 may modify in the second r-TWT parameter set one or more of the parameter values of the first r-TWT parameter set. For example, AP 1102 may modify the DL/UL TIDs that may be transmitted during the r-TWT.

In an embodiment, the second r-TWT parameter set may include the b-TWT identifier identifying the b-TWT membership group associated with the requested r-TWT.

Upon a successful exchange of TWT setup request frame 1106 and TWT setup response frame 1108, the requested r-TWT is setup between AP 1102 and STA 1104. STA 1104 is considered a member r-TWT scheduled STA of the r-TWT. In other words, STA 1104 may be allowed to transmit during service periods of the setup r-TWT. Another STA (not shown in FIG. 11) may join the setup r-TWT by exchanging TWT setup request and response frames with AP 1102. AP 1102 may also add another STA (not shown in FIG. 11) to the setup r-TWT by transmitting a TWT setup response frame to the STA.

Subsequently, AP 1102 may transmit a beacon frame 1110 including a broadcast TWT element. The broadcast TWT element may indicate the b-TWT identifier associated with the setup r-TWT and include a TWT parameter set for the setup r-TWT. The TWT parameter set may include a TWT schedule for the setup r-TWT.

As shown in FIG. 11, the TWT schedule may determine a start time 1112 of a first r-TWT SP 1114-1 of the setup r-TWT as well as start times of one or more subsequent r-TWT SP(s) of the setup r-TWT (e.g., r-TWT SP 1114-2). The TWT schedule may be indicated, without limitation, using a target wake time field and a TWT wake interval mantissa field of the broadcast TWT element. The target wake time value may indicate start time 1112 of r-TWT SP 1114-1. The TWT wake interval mantissa value may be used to determine a TWT wake interval 1116. TWT wake interval 1116 represents the amount of time separating successive r-TWT SPs of the setup r-TWT (e.g., the time between the start time 1112 of r-TWT SP 1114-1 and a start time of r-TWT SP 1114-2).

The TWT parameter set in beacon frame 1110 may also indicate a nominal minimum TWT wake duration. The nominal minimum TWT wake duration may indicate a duration of a service period (e.g., r-TWT SP 1114-1, r-TWT SP 1114-2) of the setup r-TWT.

In an example, STA 1104 may enter a doze state after receiving beacon frame 1110. STA 1104 may wake up at start time 1112 of r-TWT SP 1114-1 to exchange data frames with AP 1102.

As shown in FIG. 11, AP 1102 may transmit a trigger frame 1118 at the start of r-TWT SP 1114-1. Trigger frame 1118 triggers STA 1104 to transmit buffered traffic having a TID from among the TIDs permitted for transmission during the setup r-TWT (e.g., latency sensitive traffic). In example 1100, STA 1104 responds to trigger frame 1118 by transmitting a data frame 1120 with latency sensitive traffic. AP 1102 may acknowledge data frame 1120 by transmitting a BA frame 1122.

STA 1104 may return to the doze state at the end of r-TWT SP 1114-1 and may remain in the doze state until the start of r-TWT SP 1114-2. During r-TWT SP 1114-2, similar frame exchanges may take place. Particularly, AP 1102 may transmit a trigger frame 1124, which triggers STA 1104 to transmit a data frame 1126. AP 1102 may acknowledge data frame 1126 by transmitting a BA frame 1128.

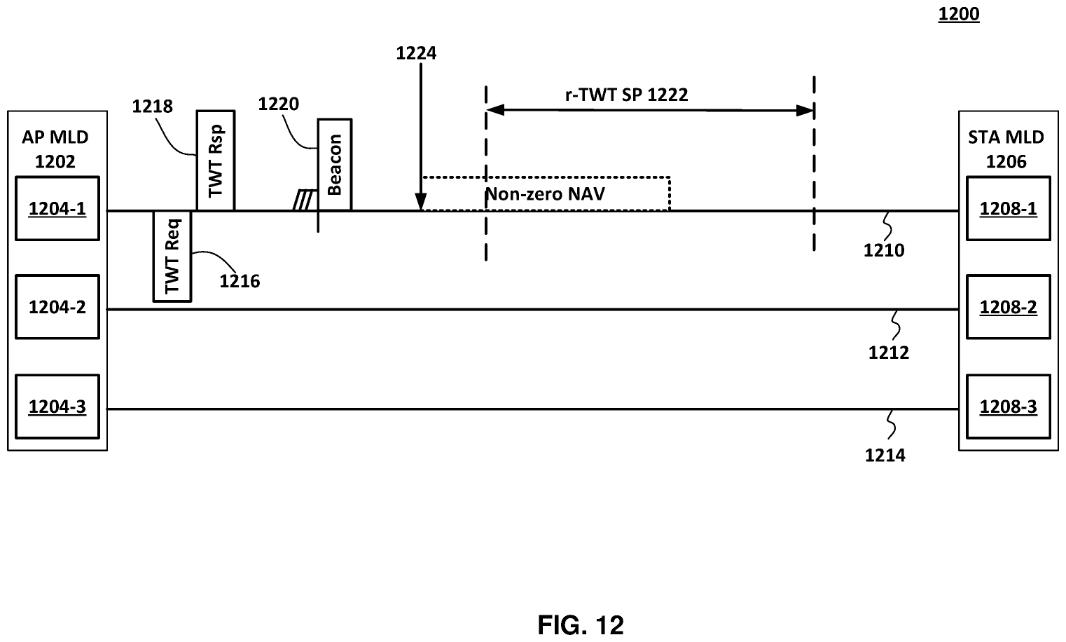

FIG. 12 illustrates an example 1200 of r-TWT operation in a multi-link environment. As shown in FIG. 12, example 1200 includes an AP MLD 1202 and a STA MLD 1206. AP MLD 1202 may have three affiliated APs 1204-1, 1204-2, and 1204-3. In an example, APs 1204-1, 1204-2, and 1204-3 may operate respectively on the 2.4 GHz band, the 5 GHz band, and the 6 GHz band. STA MLD 1206 may have three affiliated STAs 1208-1, 1208-2, and 1208-3. In an example, STAs 1208-1, 1208-2, and 1208-3 may operate respectively on the 2.4 GHz band, the 5 GHz band, and the 6 GHz band. In an example, APs 1204-1, 1204-2, and 1204-3 may be communicatively coupled via a first link 1210, a second link 1212, and a third link 1214 respectively with STAs 1208-1, 1208-2, and 1208-3, respectively.

In example 1200, STA MLD 1206 transmits, via STA 1208-1, a TWT setup request frame 1216 on first link 1210 to AP MLD 1202. TWT setup request frame 1216 requests the setup of a r-TWT. TWT setup request frame 1216 may indicate one or more TIDs to be associated with the requested r-TWT. AP MLD 1202 receives TWT setup request frame 1216 on first link 1210 via AP 1204-1. In response, AP MLD 1202 transmits, via AP 1204-1, a TWT setup response frame 1218 to STA MLD 1206. TWT setup response 1218 accepts the setup of the requested r-TWT. STA MLD 1206 receives TWT setup response frame 1218 via STA 1208-1.

Subsequently, AP MLD 1202 transmits, via AP 1204-1, a beacon frame 1220 on first link 1210. Beacon frame 1220 may include a broadcast TWT element containing a TWT schedule for the setup r-TWT. The TWT schedule indicates a start time of a r-TWT SP 1222 of the setup r-TWT.

In an example, at a time 1224 preceding the start time of r-TWT SP 1222, an event may occur on first link 1210 that causes a NAV of AP MLD 1202 for first link 1210 to have a non-zero value during a first time period of r-TWT SP 1222. For example, the event may be an initiated TXOP on first link 1210 from an overlapping BSS (OBSS) or from a STA that does not support r-TWT (and which thus does not terminate its transmission before the start time of r-TWT SP 1222).

As a result of having a non-zero NAV for first link 1210 during the first time period, AP MLD 1202 may be delayed, or may not be able, to schedule traffic for STA MLD 1206 on first link 1210 during r-TWT SP 1222. As such, the scheduled r-TWT SP 1222 may be partially or fully lost. Latency sensitive traffic for STA MLD 1206 (e.g., traffic with a TID from among the one or more TIDs associated with the setup r-TWT) may be partially or fully delayed or discarded.

To address this problem, existing technologies propose delaying r-TWT SP 1222 until AP MLD 1202 is able to schedule traffic on first link 1210 (i.e., until the NAV of AP MLD 1202 for first link 1210 returns to zero). In other words, both the start time and the end time of r-TWT SP 1222 are shifted to later times to avoid the interfering event. As such, this solution attempts to compensate STA MLD 1206 for the loss of r-TWT SP 1222 by providing another time-adjacent (delayed) r-TWT SP. However, this solution may not be adequate for transmitting latency sensitive traffic at/to STA MLD 1206. Depending on the value of the non-zero NAV of AP MLD 1202 for first link 1210, the delayed r-TWT SP may arrive too late for transmitting buffered latency sensitive traffic at/to STA MLD 1206 on first link 1210. In other words, by the time the delayed r-TWT SP arrives, a buffer overflow may have occurred at STA MLD 1206 (and/or AP MLD 1202) for one or more of the TID(s) associated with the setup r-TWT.

As further described below, embodiments of the present disclosure solve the above-described problem by leveraging the multi-link capabilities of the AP MLD and the STA MLD. When an r-TWT SP of an r-TWT setup on a first link between the AP MLD and the STA MLD may be delayed, traffic associated with the setup r-TWT may be scheduled on a second link between the AP MLD and the STA MLD. In an embodiment, the r-TWT SP scheduled on the first link may be re-scheduled on the second link. Traffic associated with the r-TWT setup on the first link may be transmitted during the re-scheduled r-TWT SP on the second link. The re-scheduled r-TWT SP on the second link may maintain the same start time and end time as the r-TWT SP initially scheduled on the first link. A TWT schedule associated with the r-TWT setup on the first link may be maintained on the first link after the re-scheduled r-TWT SP has elapsed. Traffic associated with the r-TWT setup on the first link may return to being transmitted on the first link after the re-scheduled r-TWT SP. A quiet interval schedule associated with the r-TWT setup on the first link may be maintained on the first link after the re-scheduled r-TWT SP. The STA MLD may enter a doze state on the first link during the r-TWT SP (or a remaining portion thereof) scheduled on the first link.

In another embodiment, traffic associated with the r-TWT setup on the first link may be transmitted on the second link without re-scheduling of the r-TWT SP on the second link. In an embodiment, the first link may be identified as a primary link and the second link may be identified as a secondary link during the setup of the r-TWT on the first link. Traffic associated with the r-TWT setup on the primary link may be scheduled on the secondary link without modifying or tearing down the r-TWT scheduled on the primary link. A quiet interval schedule associated with the r-TWT setup on the primary link may be maintained on the primary link. The STA MLD may enter a doze state on the primary link while traffic associated with the r-TWT setup on the primary link is transmitted on the secondary link.

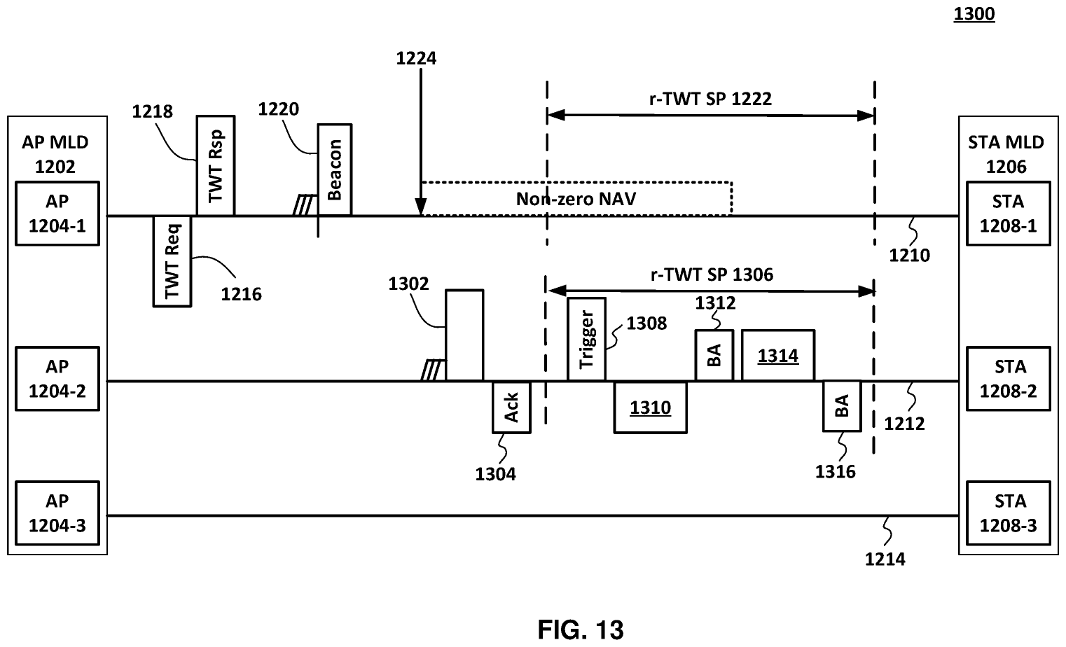

FIG. 13 illustrates an example 1300 of r-TWT operation according to an embodiment. Example 1300 is provided for the purpose of illustration only and is not limiting of embodiments of the present disclosure. As shown in FIG. 13, example 1300 includes AP MLD 1202 and STA MLD 1206 described above with reference to example 1200. AP MLD 1202 and STA MLD 1206 may be communicatively coupled via first link 1210, second link 1212, and third link 1214.

As described above with respect to example 1200, example 1300 may include STA MLD 1206 transmitting TWT setup request frame 1216 on first link 1210 to AP MLD 1202. TWT setup request frame 1216 requests the setup of ar-TWT. TWT setup request frame 1216 may indicate one or more TIDs to be associated with the requested r-TWT. In response to TWT setup request frame 1216, AP MLD 1202 transmits on first link 1210 TWT setup response frame 1218 to STA MLD 1206. TWT setup response 1218 accepts the setup of the requested r-TWT. Subsequently, AP MLD 1202 transmits beacon frame 1220 on first link 1210. Beacon frame 1220 may include a broadcast TWT element containing a TWT schedule for the setup r-TWT. The TWT schedule indicates a start time of a r-TWT SP 1222 of the setup r-TWT. Beacon frame 1220 may include a b-TWT identifier identifying a b-TWT membership group associated with the first r-TWT (hereinafter “first r-TWT”).

As in example 1200, at a time 1224 preceding the start time of r-TWT SP 1222, an event may occur on first link 1210 that causes a NAV of AP MLD 1202 for first link 1210 to have a non-zero value during a first time period of r-TWT SP 1222. As a result of having a non-zero NAV for first link 1210 during the first time period, AP MLD 1202 may be delayed, or may not be able, to schedule traffic for STA MLD 1206 on first link 1210 during r-TWT SP 1222.

In an embodiment, r-TWT SP 1222 on first link 1210 may be re-scheduled on second link 1212 as an r-TWT SP 1306. r-TWT SP 1306 may have same start and end times as r-TWT SP 1222. Alternatively, r-TWT SP 1306 may have a different start time or end time than r-TWT SP 1222. For example, r-TWT SP 1306 may start sooner or later and/or end sooner or later than r-TWT SP 1222.

In an embodiment, second link 1212 may be an enabled link (i.e., a link to which at least one TID is mapped in a traffic identifier (TID)-to-link mapping between AP MLD 1202 and STA MLD 1206). In another embodiment, second link 1212 may be a link to which traffic associated with the first r-TWT (i.e., at least one TID of the one or more TID(s) associated with the first r-TWT) is mapped in the TID-to-link mapping. In a further embodiment, second link 1212 may be a link to which the traffic associated with the first r-TWT, and sought to be re-scheduled onto second link 1212, is mapped in the TID-to-link mapping.

In an embodiment, AP MLD 1202 may transmit a frame 1302 on second link 1212 configured to reschedule r-TWT SP 1222 as r-TWT SP 1306 on second link 1212. In an embodiment, frame 1302 may include one or more of: the b-TWT identifier associated with the first r-TWT, a link identifier (ID) of first link 1210, a target wake time of the first r-TWT, and a nominal minimal wake duration associated with the first r-TWT.

In embodiments, frame 1302 may be transmitted by AP MLD 1202 before or after a start time of r-TWT SP 1222.

In an embodiment, frame 1302 may indicate allowance of STA MLD 1206 to enter a doze state on first link 1210 during r-TWT SP 1222. STA MLD 1206 may return to an awake state at the start of a next r-TWT SP (following r-TWT SP 1222) according to the TWT schedule of the first r-TWT.

In an embodiment, frame 1302 may be a TWT information frame. However, embodiments are not limited to this example. In an embodiment, frame 1302 may be contained in a multi-user (MU) physical layer protocol data unit (PPDU) transmitted by AP MLD 1202 to STA MLD 1206 on second link 1212.

In an embodiment, AP MLD 1202 may transmit frame 1302 responsive to a failure by AP MLD 1202 to schedule traffic associated with the first r-TWT, during r-TWT SP 1222, on first link 1210. In an embodiment, the failure by AP MLD 1202 to schedule the traffic associated with the first r-TWT, during r-TWT SP 1222, on first link 1210 may be due to a non-zero NAV at AP MLD 1202 for first link 1210 during a first time period of r-TWT SP 1222. The first time period may or may not include the start time or the end time of r-TWT SP 1222. The first time period may or may not be a contiguous time interval. The first time period may be greater than or equal to a defined ratio of r-TWT SP 1222 (e.g., ⅓, ½, etc.). The first time period may be the same time interval as r-TWT SP 1222.

In an embodiment, r-TWT SP 1222 may be a trigger-enabled r-TWT SP. The failure by AP MLD 1202 to schedule the traffic associated with the first r-TWT, during r-TWT SP 1222, on first link 1210 may be responsive to a failure by AP MLD 1202 to transmit a trigger frame during the first time period of the trigger-enabled r-TWT SP 1222 on first link 1210.

In an embodiment, AP MLD 1202 may transmit frame 1302 responsive to a determination by AP MLD 12020 that the medium will be busy on first link 1210 during a portion of r-TWT SP 1222 that is greater than a defined threshold (e.g., 1 ms).

Returning to FIG. 13, STA MLD 1206 may acknowledge frame 1302 (and the re-scheduling of r-TWT SP 1222 on second link 1212) by transmitting an ACK frame 1304 on second link 1212, thereby confirming the re-scheduling of r-TWT SP 1222 as r-TWT SP 1306 on second link 1212.

Subsequently, AP MLD 1202 may transmit a trigger frame 1308 on second link 1212 after the start of r-TWT SP 1306. Trigger frame 1308 triggers STA MLD 1206 to transmit a data frame 1310 containing traffic associated with the first r-TWT. AP MLD 1202 may acknowledge data frame 1310 by transmitting a BA frame 1312 to STA MLD 1206 on second link 1212. AP MLD 1202 may then transmit a data frame 1314 to STA MLD 1206 containing traffic associated with the first r-TWT. STA MLD 1206 may acknowledge data frame 1314 by transmitting a BA frame 1316 on second link 1212 to AP MLD 1202.

In an embodiment, the TWT schedule associated with the first r-TWT may be maintained on first link 1210 after re-scheduled r-TWT SP 1306 has elapsed. Specifically, traffic associated with the setup r-TWT SP may return to being transmitted on first link 1210 after re-scheduled r-TWT SP 1306. For example, during a subsequent r-TWT SP of the first r-TWT, AP MLD 1202 may transmit a trigger frame to STA MLD 1206 on first link 1210. STA MLD 1206 may respond by transmitting, on first link 1210, traffic associated with the first r-TWT.

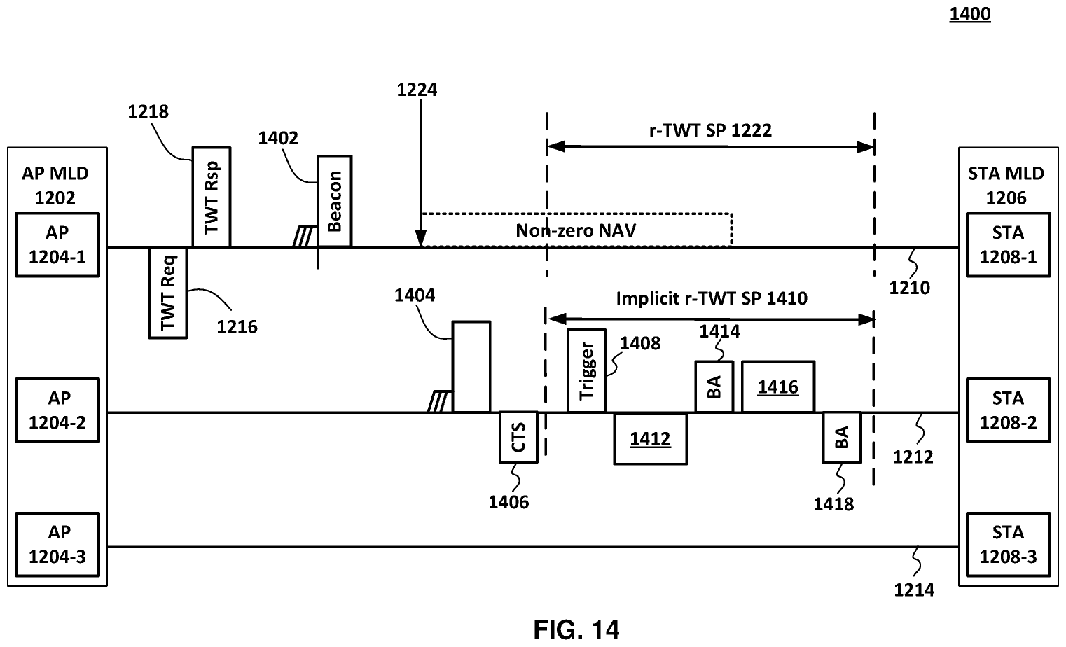

FIG. 14 illustrates an example 1400 of r-TWT operation according to an embodiment. Example 1400 is provided for the purpose of illustration only and is not limiting of embodiments of the present disclosure. As shown in FIG. 14, example 1400 includes AP MLD 1202 and STA MLD 1206 described above with reference to example 1200. AP MLD 1202 and STA MLD 1206 may be communicatively coupled via first link 1210, second link 1212, and third link 1214.

As described above with respect to example 1200, example 1400 may include STA MLD 1206 transmitting TWT setup request frame 1216 on first link 1210 to AP MLD 1202. TWT setup request frame 1216 requests the setup of a r-TWT. TWT setup request frame 1216 may indicate one or more TIDs to be associated with the requested r-TWT. In response to TWT setup request frame 1216, AP MLD 1202 transmits on first link 1210 TWT setup response frame 1218 to STA MLD 1206. TWT setup response 1218 accepts the setup of the requested r-TWT.

Subsequently, AP MLD 1202 transmits a beacon frame 1402 on first link 1210. Beacon frame 1402 may include a broadcast TWT element containing a TWT schedule for the setup r-TWT. The TWT schedule indicates a start time of a r-TWT SP 1222 of the setup r-TWT.

As in example 1200, at a time 1224 preceding the start time of r-TWT SP 1222, an event may occur on first link 1210 that causes a NAV of AP MLD 1202 for first link 1210 to have a non-zero value during a first time period of r-TWT SP 1222. As a result of having a non-zero NAV for first link 1210 during the first time period, AP MLD 1202 may be delayed, or may not be able, to schedule traffic for STA MLD 1206 on first link 1210 during r-TWT SP 1222.

In an embodiment, traffic associated with the first r-TWT may be transmitted on second link 1212 without explicitly re-scheduling r-TWT SP 1222 on second link 1212. In an embodiment, first link 1210 may be identified as a primary link and second link 1212 may be identified as a secondary link during the setup of the r-TWT on first link 1210. The information identifying first link 1210 as a primary link and second link 1212 as a secondary link for the setup r-TWT may be indicated in beacon frame 1402. When traffic associated with the setup r-TWT cannot be transmitted on first link 1210 (i.e., the primary link), AP MLD 1202 may schedule the traffic on second link 1212 (i.e., the secondary link). In an embodiment, AP MLD 1202 may obtain a TXOP on second link 1212 and may protect the TXOP by preceding it with an RTS/CTS exchange on second link 1212. As illustrated in FIG. 14, the TXOP may represent an “implicit” r-TWT SP 1410 on second link 1212. In an embodiment, the TXOP on second link 1212 may be configured to be time-aligned with r-TWT SP 1222 on first link 1210. In other embodiments, however, the TXOP may not be time-aligned with r-TWT SP 1222. For example, the TXOP may start sooner or later and/or end sooner or later than r-TWT SP 1222. Further, the TXOP may be shorter or longer than r-TWT SP 1222. The traffic associated with the first r-TWT may be transmitted during the obtained TXOP on second link 1212.

In an embodiment, second link 1212 may be an enabled link (i.e., a link to which at least one TID is mapped in a traffic identifier (TID)-to-link mapping between AP MLD 1202 and STA MLD 1206). In another embodiment, second link 1212 may be a link to which traffic associated with the first r-TWT (i.e., at least one TID of the one or more TID(s) associated with the first r-TWT) is mapped in the TID-to-link mapping. In a further embodiment, second link 1212 may be a link to which the traffic associated with the first r-TWT, and sought to be re-scheduled onto second link 1212, is mapped in the TID-to-link mapping.

In an embodiment, AP MLD 1202 may transmit a multi-user (MU)-Request-to-Send (RTS) frame 1404 on second link 1212 to initiate scheduling, on second link 1212, of traffic associated with the first r-TWT. A duration field of MU-RTS frame 1404 may be set such that the obtained TXOP forms an “implicit” r-TWT SP 1410 on second link 1212 that is time-aligned with r-TWT SP 1222 scheduled on first link 1210. In other embodiments, however, the TXOP may not be time-aligned with r-TWT SP 1222. For example, the TXOP may start sooner or later and/or end sooner or later than r-TWT SP 1222. Further, the TXOP may be shorter or longer than r-TWT SP 1222.

MU-RTS frame 1404 may indicate STA MLD 1206 as a recipient. In an embodiment, MU-RTS frame 1404 may include a b-TWT identifier associated with the first r-TWT. Alternatively, or additionally, MU-RTS frame 1404 may indicate one or more TIDs of the TIDs associated with the first r-TWT.

In an embodiment, MU-RTS frame 1404 may indicate allowance of STA MLD 1206 to enter a doze state on first link 1210 during r-TWT SP 1222. STA MLD 1206 may return to an awake state at the start of a next r-TWT SP (following r-TWT SP 1222) according to the TWT schedule of the first r-TWT. In another embodiment, allowance to enter the doze state may be indicated in another frame transmitted after MU-RTS frame 1404. The other frame may be a control frame or a QoS null frame.

In embodiments, MU-RTS frame 1404 may be transmitted by AP MLD 1202 before or after a start time of r-TWT SP 1222.

STA MLD 1206 responds to MU-RTS frame 1404 with a CTS frame 1406. CTS frame 1406 indicates to AP MLD 1202 that STA MLD 1206 is ready to exchange, on second link 1212, traffic associated with the first r-TWT.

Subsequently, AP MLD 1202 may transmit a trigger frame 1408 to STA MLD 1206 on second link 1212. Trigger frame 1408 may be transmitted during r-TWT SP 1222 scheduled on first link 1210. Trigger frame 1408 triggers STA MLD 1206 to transmit a data frame 1412 containing traffic associated with the first r-TWT. AP MLD 1202 may acknowledge data frame 1412 by transmitting a BA frame 1414 to STA MLD 1206 on second link 1212. AP MLD 1202 may then transmit a data frame 1416 to STA MLD 1206 containing traffic associated with the first r-TWT. STA MLD 1206 may acknowledge data frame 1416 by transmitting a BA frame 1418 on second link 1212 to AP MLD 1202.

In another embodiment, AP MLD 1202 may not precede the obtained TXOP on second link 1211 with an RTS/CTS exchange. As such, AP MLD 1202 may directly transmit trigger frame 1408 to initiate the scheduling of traffic associated with the setup r-TWT on second link 1212. Trigger frame 1408 may be transmitted before or within r-TWT SP 1222. STA MLD 1206 responds to trigger frame 1408 by transmitting a data frame containing traffic associated with the first r-TWT.

In an embodiment, the TWT schedule associated with the first r-TWT may be maintained on first link 1210. Specifically, traffic associated with the setup r-TWT may return to being transmitted on first link 1210 after r-TWT SP 1222. For example, during a subsequent r-TWT SP of the first r-TWT, AP MLD 1202 may transmit a trigger frame to STA MLD 1206 on first link 1210. STA MLD 1206 may respond by transmitting, on first link 1210, traffic associated with the first r-TWT.

In an embodiment, AP MLD 1202 may transmit MU-RTS frame 1404 (or directly trigger frame 1408) responsive to a failure by AP MLD 1202 to schedule traffic associated with the first r-TWT, during r-TWT SP 1222, on first link 1210. In an embodiment, the failure by AP MLD 1202 to schedule the traffic associated with the first r-TWT, during r-TWT SP 1222, on first link 1210 may be due to a non-zero NAV at AP MLD 1202 for first link 1210 during a first time period of r-TWT SP 1222. The first time period may or may not include the start time or the end time of r-TWT SP 1222. The first time period may or may not be a contiguous time interval. The first time period may be greater than or equal to a defined ratio of r-TWT SP 1222 (e.g., ⅓, ½, etc.). The first time period may be the same time interval as r-TWT SP 1222.

In an embodiment, r-TWT SP 1222 may be a trigger-enabled r-TWT SP. The failure by AP MLD 1202 to schedule the traffic associated with the first r-TWT during r-TWT SP 1222 on first link 1210 may be responsive to a failure by AP MLD 1202 to transmit a trigger frame during the first time period of the trigger-enabled r-TWT SP 1222 on first link 1210.

In an embodiment, AP MLD 1202 may transmit frame 1302 responsive to a determination by AP MLD 12020 that the medium will be busy on first link 1210 during a portion of r-TWT SP 1222 that is greater than a defined threshold (e.g., 1 ms).

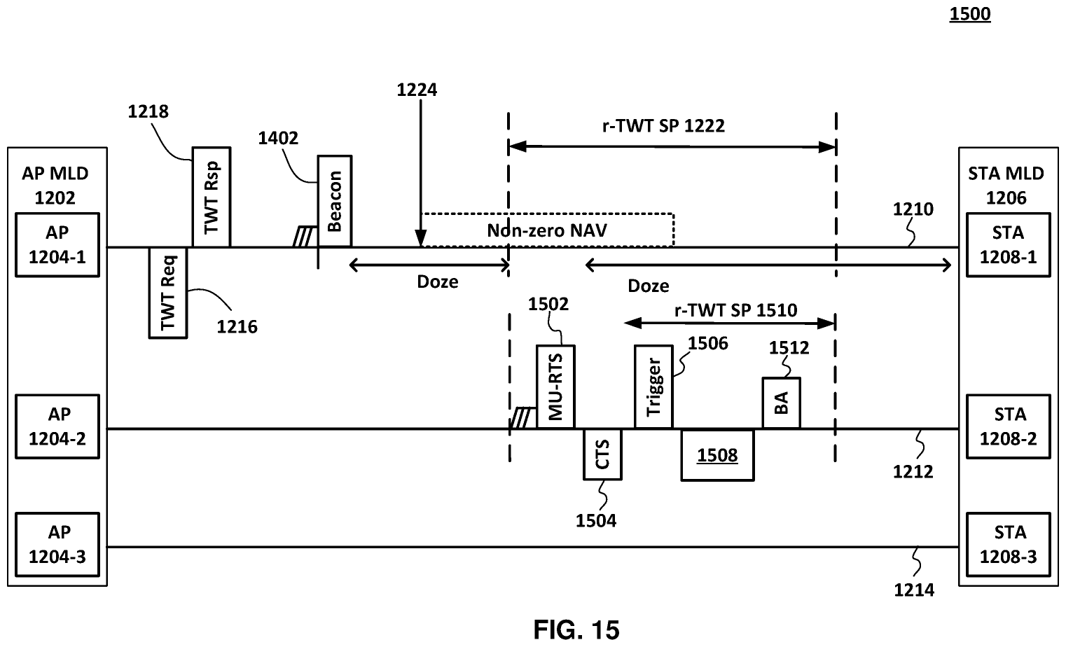

FIG. 15 illustrates an example 1500 of r-TWT operation according to an embodiment of the present disclosure. Example 1500 is provided for the purpose of illustration only and is not limiting of embodiments of the present disclosure. As shown in FIG. 15, example 1500 includes AP MLD 1202 and STA MLD 1206 described above with reference to example 1200. AP MLD 1202 and STA MLD 1206 may be communicatively coupled via first link 1210, second link 1212, and third link 1214.

As described above with respect to example 1200, example 1500 may include STA MLD 1206 transmitting TWT setup request frame 1216 on first link 1210 to AP MLD 1202. TWT setup request frame 1216 requests the setup of a r-TWT. TWT setup request frame 1216 may indicate one or more TIDs to be associated with the requested r-TWT. In response to TWT setup request frame 1216, AP MLD 1202 transmits on first link 1210 TWT setup response frame 1218 to STA MLD 1206. TWT setup response 1218 accepts the setup of the requested r-TWT.

Subsequently, AP MLD 1202 transmits beacon frame 1402 on first link 1210. Beacon frame 1402 may include a broadcast TWT element containing a TWT schedule for the setup r-TWT. The TWT schedule indicates a start time of a r-TWT SP 1222 of the setup r-TWT. As described above with respect to example 1400, beacon frame 1402 may include information identifying first link 1210 as a primary link and second link 1212 as a secondary link for the setup r-TWT. As such, traffic associated with the first r-TWT may be scheduled for transmission on second link 1212 during an “implicit” r-TWT SP as discussed above with respect to example 1400.

As in example 1200, at a time 1224 preceding the start time of r-TWT SP 1222, an event may occur on first link 1210 that causes a NAV of AP MLD 1202 for first link 1210 to have a non-zero value during a first time period of r-TWT SP 1222. As a result of having a non-zero NAV for first link 1210 during the first time period, AP MLD 1202 may be delayed, or may not be able, to schedule traffic for STA MLD 1206 on first link 1210 during r-TWT SP 1222.

In an embodiment, AP MLD 1202 may transmit an MU-RTS frame 1502 on second link 1212 to initiate scheduling, on second link 1212, of traffic associated with the first r-TWT. MU-RTS frame 1502 may be transmitted before the start of r-TWT SP 1222 or after the start of r-TWT SP 1222 as shown in example 1500. STA MLD 1206 responds to MU-RTS frame 1502 with a CTS frame 1504. CTS frame 1506 indicates to AP MLD 1202 that STA MLD 1206 is ready to exchange, on second link 1212, traffic associated with the first r-TWT. The MU-RTS/CTS exchange configures a protected TXOP on second link 1212. The protected TXOP may represent an implicit r-TWT SP 1510 on second link 1212 as illustrated in FIG. 15. In an example, as shown in FIG. 15, r-TWT SP 1510 may start after the start of r-TWT SP 1222 and may end at the same time as r-TWT SP 1222. However, embodiments are not limited by this example as would be understood by a person of skill in the art based on the teachings herein.

Subsequently, AP MLD 1202 may transmit a trigger frame 1506 to STA MLD 1206 on second link 1212. Trigger frame 1506 may be transmitted during r-TWT SP 1222 scheduled on first link 1210. Trigger frame 1506 triggers STA MLD 1206 to transmit a data frame 1508 containing traffic associated with the first r-TWT. AP MLD 1202 may acknowledge data frame 1508 by transmitting a BA frame 1512 to STA MLD 1206 on second link 1212.

MU-RTS frame 1502 may indicate allowance of STA MLD 1206 to enter a doze state on first link 1210 during a remaining portion of r-TWT SP 1222. In an embodiment, as shown in example 1500, STA MLD 1206 enters the doze state on first link 1210 upon receiving MU-RTS frame 1502 on second link 1212. STA MLD 1206 may return to an awake state at the start of a next r-TWT SP (following r-TWT SP 1222) according to the TWT schedule of the first r-TWT. In another embodiment, allowance to enter the doze state may be indicated in another frame transmitted after MU-RTS frame 1502. For example, the allowance to enter doze state may be included in trigger frame 1506.

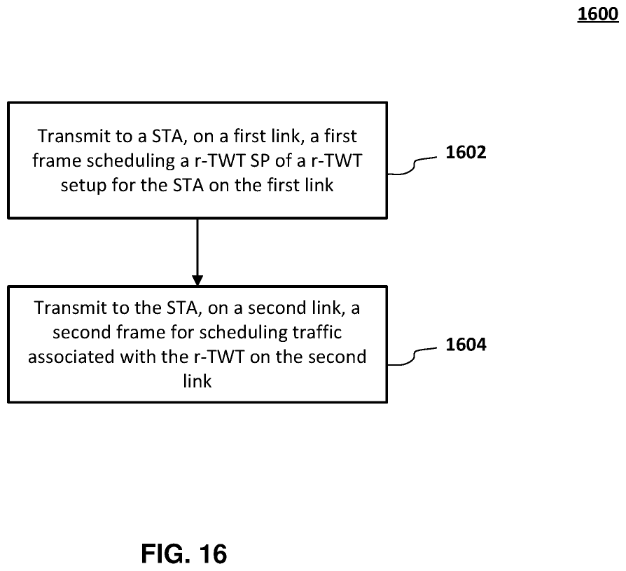

FIG. 16 illustrates an example process 1600 according to an embodiment. Example process 1600 is provided for the purpose of illustration only and is not limiting of embodiments. Example process 1600 may be performed by an AP, such as AP MLD 1202, for example. As shown, example process 1600 includes steps 1602 and 1604.

In step 1602, process 1600 includes transmitting, to a STA, on a first link, a first frame scheduling a r-TWT SP of a r-TWT setup for the STA on the first link.

In an embodiment, the first frame may be a beacon frame, may include a b-TWT identifier identifying a b-TWT membership group associated with the r-TWT setup on the first link, and/or may include information identifying the first link as a primary link and a second link between the AP and the STA as a secondary link.

In step 1604, process 1600 includes transmitting, to the STA, on a second link, a second frame for scheduling traffic associated with the r-TWT on the second link.

In an embodiment, the transmitting of the second frame is responsive to a failure by the AP to schedule the traffic associated with the r-TWT during the r-TWT SP on the first link. In an embodiment, the failure by the AP to schedule the traffic associated with the r-TWT during the r-TWT SP on the first link is due to a non-zero NAV at the AP for the first link during a first time period of the r-TWT SP. The first time period may be greater than a defined ratio of the r-TWT SP.

In an embodiment, the r-TWT is a trigger-enabled r-TWT. The failure by the AP to schedule the traffic associated with the r-TWT during the r-TWT SP on the first link may be, additionally or alternatively, responsive to a failure by the AP to transmit a trigger frame during the first time period of the r-TWT SP on the first link.

In another embodiment, the transmitting of the second frame may be responsive to a determination by the AP that the medium will be busy on the first link during a portion of the r-TWT SP that is greater than a defined threshold.

The traffic associated with the r-TWT may be mapped to the second link in a TID-to-link mapping between the AP and the STA. The second link may be an enabled link.

The transmitting of the second frame may include transmitting the second frame before or after a start time of the r-TWT SP scheduled on the first link. The transmitting of the second frame may include transmitting a multi-user (MU) physical layer protocol data unit (PPDU) containing the second frame.

In an embodiment, the second frame is configured to reschedule the r-TWT SP on the second link. The r-TWT SP rescheduled on the second link may same start and end times as the r-TWT SP scheduled on the first link. The second frame may include the b-TWT identifier associated with the r-TWT, a link ID of the first link, a target wake time, and/or a nominal minimal wake duration associated with the r-TWT.

In an embodiment, the second frame includes a TWT information frame.

In another embodiment, the second frame includes an MU-RTS frame. Example process 1600 may further include, after step 1604, receiving, from the STA, a CTS frame on the second link in response to the MU-RTS frame.

In an embodiment, example process 1600 may further include after step 1604: transmitting, to the STA, a trigger frame on the second link; and receiving, from the STA, on the second link, traffic associated with the r-TWT in response to the trigger frame. The trigger frame may be transmitted during the r-TWT SP scheduled on the first link.

In another embodiment, the second frame includes a trigger frame. Example process 1600 may further include after step 1604: receiving, from the STA, on the second link, traffic associated with the r-TWT in response to the second frame.

The traffic associated with the r-TWT may be received during the r-TWT SP scheduled on the first link.

The second frame may indicate allowance of the STA to enter a doze state on the first link during the r-TWT SP. Alternatively or additionally, process 1600 may include transmitting a third frame indicating allowance of the STA to enter a doze state on the first link during the r-TWT SP. The third frame may be a control frame or a QoS null frame.

In an embodiment, process 1600 may further include, after step 1604: transmitting, to the STA, on the first link, a trigger frame during a subsequent r-TWT SP of the r-TWT setup on the first link; and receiving traffic associated with the r-TWT on the first link during the subsequent r-TWT SP.

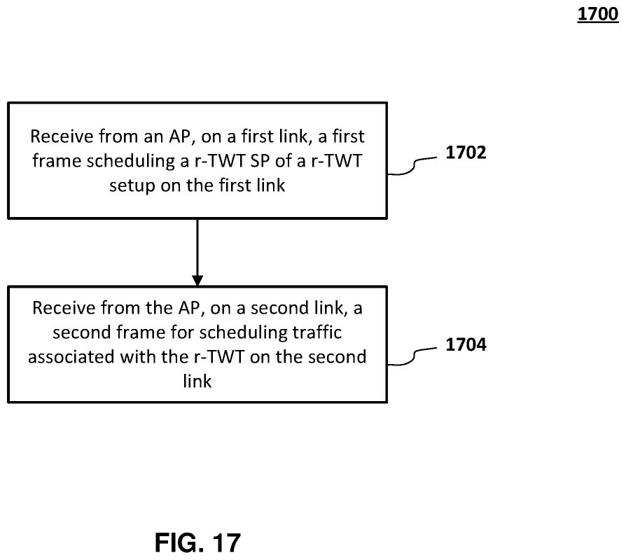

FIG. 17 illustrates an example process 1700 according to an embodiment. Example process 1700 is provided for the purpose of illustration only and is not limiting of embodiments. Example process 1700 may be performed by a STA, such as STA MLD 1206, for example. As shown, example process 1700 includes steps 1702 and 1704.

In step 1702, process 1700 includes receiving, from an AP, on a first link, a first frame scheduling a r-TWT SP of a r-TWT setup for the STA on the first link.

In an embodiment, the first frame may be a beacon frame, may include a b-TWT identifier identifying a b-TWT membership group associated with the r-TWT setup on the first link, and/or may include information identifying the first link as a primary link and a second link between the AP and the STA as a secondary link.

In step 1704, process 1700 includes receiving, from the AP, on a second link, a second frame for scheduling traffic associated with the r-TWT on the second link.

In an embodiment, the second frame may be transmitted by the AP responsive to a failure by the AP to schedule the traffic associated with the r-TWT during the r-TWT SP on the first link. In an embodiment, the failure by the AP to schedule the traffic associated with the r-TWT during the r-TWT SP on the first link is due to a non-zero NAV at the AP for the first link during a first time period of the r-TWT SP. The first time period may be greater than a defined ratio of the r-TWT SP.

In an embodiment, the r-TWT is a trigger-enabled r-TWT. The failure by the AP to schedule the traffic associated with the r-TWT during the r-TWT SP on the first link may be, additionally or alternatively, responsive to a failure by the AP to transmit a trigger frame during the first time period of the r-TWT SP on the first link.

In another embodiment, the second frame may be transmitted by the AP be responsive to a determination by the AP that the medium will be busy on the first link during a portion of the r-TWT SP that is greater than a defined threshold.

The traffic associated with the r-TWT may be mapped to the second link in a TID-to-link mapping between the AP and the STA. The second link may be an enabled link.

The receiving of the second frame may include receiving the second frame before or after a start time of the r-TWT SP scheduled on the first link. The receiving of the second frame may include receiving a multi-user (MU) physical layer protocol data unit (PPDU) containing the second frame.

In an embodiment, the second frame is configured to reschedule the r-TWT SP on the second link. The r-TWT SP rescheduled on the second link may same start and end times as the r-TWT SP scheduled on the first link. The second frame may include the b-TWT identifier associated with the r-TWT, a link ID of the first link, a target wake time, and/or a nominal minimal wake duration associated with the r-TWT.

In an embodiment, the second frame includes a TWT information frame.

In another embodiment, the second frame includes an MU-RTS frame. Example process 1700 may further include, after step 1704, transmitting, to the AP, a CTS frame on the second link in response to the MU-RTS frame.

In an embodiment, example process 1700 may further include after step 1704: receiving, from the AP, a trigger frame on the second link; and transmitting, to the AP, on the second link, traffic associated with the r-TWT in response to the trigger frame. The trigger frame may be received during the r-TWT SP scheduled on the first link.

In another embodiment, the second frame includes a trigger frame. Example process 1700 may further include after step 1704: transmitting, to the AP, on the second link, traffic associated with the r-TWT in response to the second frame.

The traffic associated with the r-TWT may be transmitted during the r-TWT SP scheduled on the first link.

The second frame may indicate allowance of the STA to enter a doze state on the first link during the r-TWT SP. Alternatively or additionally, process 1700 may include receiving a third frame indicating allowance of the STA to enter a doze state on the first link during the r-TWT SP. The third frame may be a control frame or a QoS null frame. Process 1700 may include entering the doze state in response to the second or third frame.

In an embodiment, process 1700 may further include, after step 1704: receiving, from the AP, on the first link, a trigger frame during a subsequent r-TWT SP of the r-TWT setup on the first link; and transmitting traffic associated with the r-TWT on the first link during the subsequent r-TWT SP.

1. An access point (AP) multi-link device (MLD) comprising:
one or more processors; and
memory storing instructions that, when executed by the one or more processors, cause the AP MLD to:
transmit to a non-access point (non-AP) MLD, on a first link, a first frame scheduling a restricted target wake time (r-TWT) service period (SP) of a r-TWT setup for the non-AP MLD on the first link; and
transmit to the non-AP MLD, on a second link, a second frame for scheduling traffic associated with the r-TWT on the second link.

2. The AP MLD of claim 1, wherein the second frame is configured to reschedule the r-TWT SP on the second link.

3. The AP MLD of claim 2, wherein the r-TWT SP rescheduled on the second link has same start and end times as the r-TWT SP scheduled on the first link.

4. The AP MLD of claim 1, wherein the first frame includes a broadcast TWT (b-TWT) identifier identifying a b-TWT membership group associated with the r-TWT setup on the first link.

5. The AP MLD of claim 4, wherein the second frame includes the b-TWT identifier.

6. The AP MLD of claim 1, wherein the second frame includes a link identifier (ID) of the first link.

7. The AP MLD of claim 1, wherein the second frame comprises a trigger frame, and wherein the instructions, when executed by the one or more processors, further cause the AP MLD to receive, from the non-AP MLD, one the second link, the traffic associated with the r-TWT in response to the second frame.

8. The AP MLD of claim 1, wherein the instructions, when executed by the one or more processors, further cause the AP MLD to transmit a third frame indicating allowance of the non-AP MLD to enter a doze state on the first link during the r-TWT SP.

9. The AP MLD of claim 1, wherein the second frame indicates allowance of the non-AP MLD to enter a doze state on the first link during the r-TWT SP.

10. A non-access point (non-AP) multi-link device (MLD) comprising:
one or more processors; and
memory storing instructions that, when executed by the one or more processors, cause the non-AP MLD to:
receive from an access point (AP) MLD, on a first link, a first frame scheduling a restricted target wake time (r-TWT) service period (SP) of a r-TWT setup for the non-AP MLD on the first link; and
receive from the AP MLD, on a second link, a second frame for scheduling traffic associated with the r-TWT on the second link.

11. The non-AP MLD of claim 10, wherein the second frame is configured to reschedule the r-TWT SP on the second link.

12. The non-AP MLD of claim 11, wherein the r-TWT SP rescheduled on the second link has same start and end times as the r-TWT SP scheduled on the first link.

13. The non-AP MLD of claim 10, wherein the first frame includes a broadcast TWT (b-TWT) identifier identifying a b-TWT membership group associated with the r-TWT setup on the first link.

14. The non-AP MLD of claim 13, wherein the second frame includes the b-TWT identifier.

15. The non-AP MLD of claim 10, wherein the second frame includes a link identifier (ID) of the first link.

16. The non-AP MLD of claim 10, wherein the second frame includes a trigger frame, and wherein the instructions, when executed by the one or more processors, further cause the non-AP MLD to transmit to the AP MLD, on the second link, the traffic associated with the r-TWT in response to the second frame.

17. The non-AP MLD of claim 10, wherein the instructions, when executed by the one or more processors, further cause the non-AP MLD to receive a third frame indicating allowance of the non-AP MLD to enter a doze state on the first link during the r-TWT SP.

18. The non-AP MLD of claim 10, wherein the instructions, when executed by the one or more processors, further cause the non-AP MLD to:
receive from the AP MLD, on the first link, a trigger frame during a subsequent r-TWT SP of the r-TWT setup on the first link; and
transmit traffic associated with the r-TWT on the first link during the subsequent r-TWT SP.

19. A non-transitory computer-readable medium comprising instructions that, when executed by one or more processors, cause the one or more processors of an access point (AP) multi-link device (MLD), cause the AP MLD to:
transmit to a non-access point (non-AP) MLD, on a first link, a first frame scheduling a restricted target wake time (r-TWT) service period (SP) of a r-TWT setup for the non-AP MLD on the first link; and
transmit to the non-AP MLD, on a second link, a second frame for scheduling traffic associated with the r-TWT on the second link.

20. The non-transitory computer-readable medium of claim 19, wherein the first frame includes a broadcast TWT (b-TWT) identifier identifying a b-TWT membership group associated with the r-TWT setup on the first link, and wherein the second frame includes the b-TWT identifier.
